(19) United States
(12) Patent Application Publication
(10) Pub. No.: US 2020/0346897 A1
(43) Pub. Date: Nov. 5, 2020

(54) STAIR LIFT DEVICE

(71) Applicant: LOREN DAVIS, Carrboro, NC (US)

(72) Inventor: LOREN DAVIS, Carrboro, NC (US)

(21) Appl. No.: 16/400,127

(22) Filed: May 1, 2019

(51) Int. Cl. B66B 9/08

(52) U.S. Cl. CPC B66B 9/08; B66B 9/0846; B66B 9/0853; B66B 9/0807

(57) ABSTRACT

A personal stair lift device transports a handicapped or immobile individual of higher than average weight capacity up and down a stairway on a chair assembly supported on a dual rail mount assembly. The stair lift device is used on a stairway on a dual track system aligned on both sides of the stairwell, connected to dual metal pipes, and is further connected to a plurality of metal brackets, containing steel braided cables. Braided cables are connected to guide wheels that can lift heavier weight capacity individuals.

### FIELD OF THE INVENTION

The present invention relates to a lift device. More particularly, the invention pertains to a personal stair lift to transport an individual up and down a stairway utilizing a chair support on a dual rail mounted rack.

### BACKGROUND OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

Currently, most stair lift devices are limited to a certain weight transport due to a lift device attaching to only one side of the staircase. Additionally, current lift devices are specifically designed to support standard weight capacities for the average male or female.

Additionally, current stair lift devices are not capable of pivoting on spiral staircases to allow straight line transport without stopping during operation. Furthermore, while current stair lift devices may provide transport up and down stairways, current stair lift devices do not allow a pivot without stopping on the staircase while supporting greater weight capacities of handicapped or immobile individuals.

For the foregoing reasons, there is a need for a stair lift device that allows for safe transport of handicapped or immobile individuals of greater weight capacities up and down stairways.

### SUMMARY OF THE INVENTION

The present invention relates to a personal stair lift to move or transport an individual of higher than average weight capacity safely up and down a stairway on a chair assembly support on a dual rail assembly by a chassis assembly powered by a lift mechanism. The device comprises a stairlift device comprising a hinged carriage assembly, a dual parallel rail assembly, a chassis/roller assembly with a plurality of guide wheel rollers on both sides, an electrical drive lift mechanism with a cable and pulley mechanism supported by a winch and anchor system, and a docking assembly. The stair lift device is comprised of a platform or carriage with side guard bars and a gate at the forward end of the movable platform/carriage and another gate at the rear. In an embodiment of the invention, the device is a lift device for heavy weight capacities. In another embodiment of the present invention, the carriage rides on two parallel rails, located at each side of the staircase at the bottom. In certain embodiments, the two rails are made of tubular steel and are connected to the stairs by metal, vertical brackets bolted at intervals to the rails. Alternatively, the two rails are made of other metal alloys and connected to the stairs by metal alloys, or metal support brackets bolted at intervals to the rails.

An embodiment of the invention provides brackets with lower sleeves or pulleys to minimize friction from the drive cable. A further embodiment of the invention comprises a platform or carriage that is connected to the round dual rails by guide wheel rollers riding on top of each rail.

In one embodiment, the stair lift device comprises a platform/carriage hinged in the middle, a parallel dual rail assembly having an upper and lower surface fixedly attached to each side of the staircase affixed with metal support brackets coupled with guide wheel rollers that are placed in intervals along the rails equipped with pulley sleeves and rollers, a chassis/roller with a plurality of guide wheel rollers held in rolling engagement with the upper and lower surfaces of the round rails, a drive or lift mechanism supported by winch and anchor system, and a docking assembly ramp. In one exemplary embodiment, the hinged carriage assembly has side guard bars and a front and rear end gate. The top of the lift device has a safety bar, and the bottom of the lift device contains a safety bar.

In yet another embodiment, the platform/carriage is moved up and down the dual rail system by at least one braided steel cable running from a 12-volt electric winch with rechargeable battery located at the top of the staircase. In one embodiment, the stair lift device further consists of at least one braided steel cable that runs down the outside of the staircase, passing over guide wheel rollers integrated with the metal support brackets. In a further embodiment, at least one braided steel cable passes over pulled mounted to the front end of the carriage to the opposite side of the staircase anchored at the top of the staircase opposite the winch.

In still another embodiment, the plurality of metal support brackets is bolted at intervals to the rails incorporating lower sleeves or pulleys to minimize friction from the drive cable.

In one embodiment, the stair lift device is connected to round rails by concave guide wheels riding on the top of each rail.

In yet another embodiment, there is a ramp at the bottom of the staircase to access the carriage for moving up or down the stairs through the middle-docked carriage.

In still another embodiment, the carriage is equipped with a folding ramp in place of the carriage's lower door or gate.

In still yet another embodiment, the carriage allows access for transport for people in wheelchairs, with walkers, or standing.

Various objects, features, aspects and advantages of the inventive subject matter will become more apparent from the following detailed description of exemplary embodiments, along with the accompanying figures in which like numerals represent like components.

### BRIEF DESCRIPTION OF THE DRAWINGS

FIG. 1 is an exemplary perspective view of the stair lift device of the present invention mounted in operative relationship relative to a stairway.

FIG. 2 is a detailed view of a cross-section of the chassis assembly of a stair lift device.

FIG. 3 is an exemplary configuration of a top view of the docking assembly of a stair lift device.

FIG. 4 is an exemplary configuration of a top view of the rail assembly of a stair lift device.

FIG. 5 is a detailed exemplary configuration of the rail and chassis assembly of a stair lift device.

### DETAILED DESCRIPTION

A stair lift device with a dual parallel rail assembly for a user is designed and manufactured to transport individuals of higher weight capacities safely up and down stairways.

Furthermore, as used herein, and unless the context dictates otherwise, the term “user” is intended to include any human needing transport up and down a stairway. The term “assembly” and “configuration” are used interchangeably in the description herein. The terms “stair lift device”, and “lift device” are used interchangeably in the description herein.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute of the numeral to 10% above the absolute of the numeral, inclusive.

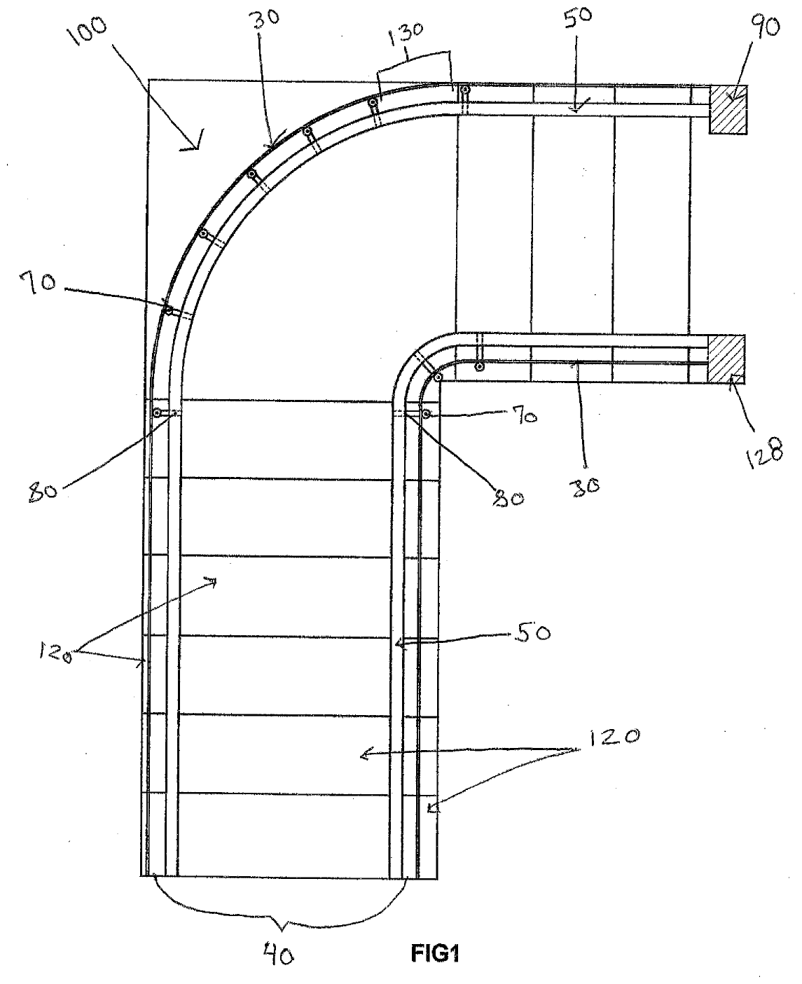

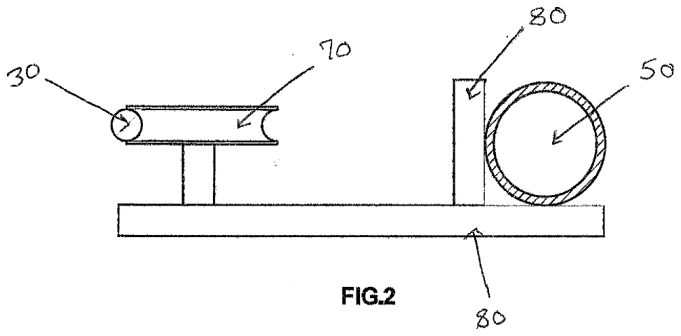

An exemplary configuration is schematically depicted in FIG. 1, in which stair lift device 100 configured to be used on a staircase comprises a dual track rail system 40 on both sides of the staircase connected to a dual pipe track 50. In one embodiment, the staircase 120 will be supported by a foundation wall on the left side and no foundation wall on the right side of the staircase 120. In another embodiment, the staircase 120 will be supported be a foundation wall on the left side and a foundation wall on the right side of the staircase 120. The dual pipe tracks 50 comprising the dual track rail system 40 run along the inner left and right sides of the staircase. In one embodiment, the dual pipe tracks 50 are cylindrical. A plurality of metal support brackets 80 are further mounted to the staircase 120 by a plurality of metal bolts to support the dual pipe tracks 50 running the length of the staircase 120. In one embodiment, the metal support brackets 80 are mounted in intervals 130 of every other step for support purposes. In another embodiment, the metal support brackets 80 are mounted in intervals 130 of every third step for support purposes. In another embodiment, the metal support brackets 80 are mounted at every step for support purposes. In one embodiment, the plurality of metal support brackets 80 contain at least one steel braided cable 30 that is connected to a plurality of cable guide wheels 70 and the steel braided cable 30 is located inside the dual pipe track 50 adapted for lifting heavier weight capacity users. In one embodiment, at least one steel braided cable 30 is anchored at the top of the stairwell at an anchor point 128, and powered by an electrical winch 90. In an embodiment, carriage (not shown) moves up and down along the dual track rail system 40 powered by at least one steel braided cable 30 that runs along the inner left and right side of the staircase, passing over a plurality of guide wheel rollers 70 integrated with a plurality of metal brackets 80. In one embodiment, a plurality of metal support brackets 80 include a predetermined spacing 130 (see FIG. 1) with a plurality of guide wheels 70 and a dual pipe track 50 on both sides of the staircase 120 connected to run on the dual rail track system 40 (see FIG. 2). In an embodiment, the metal support brackets 80 are about 20 cm to about 25 cm apart. In one embodiment, metal brackets 80 are about 10 cm to about 15 cm apart. In an alternative embodiment, metal brackets 80 are about 5 cm apart to account for varying staircase heights and varying weight capacities.

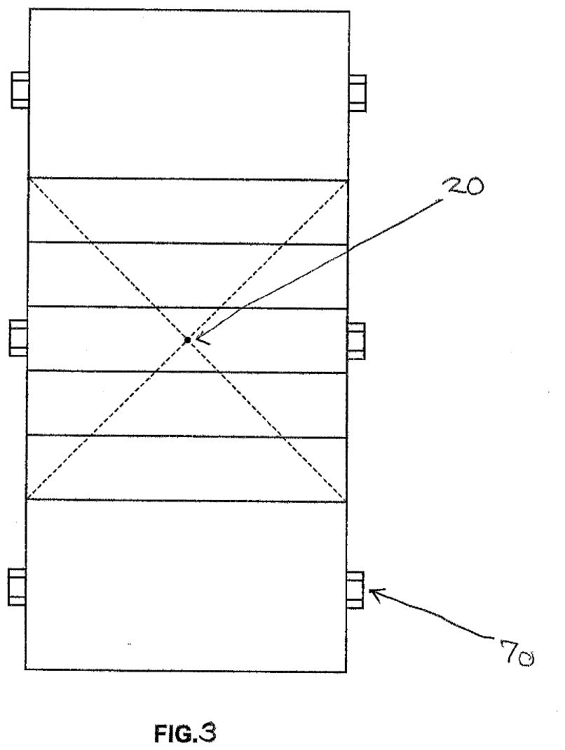

In one embodiment, the carriage is stationed on a pivot platform carriage 20 hinged in the middle (see FIG. 3) and designed to allow easier motion around corners (see FIG. 1) to allow device 100 to move around corners (not shown). In an exemplary embodiment, a pivot platform carriage 20 hinged in the middle is positioned on two parallel dual pipe tracks 50 on both sides of the staircase 120 such that heavier weight individuals can be transported on device 100.

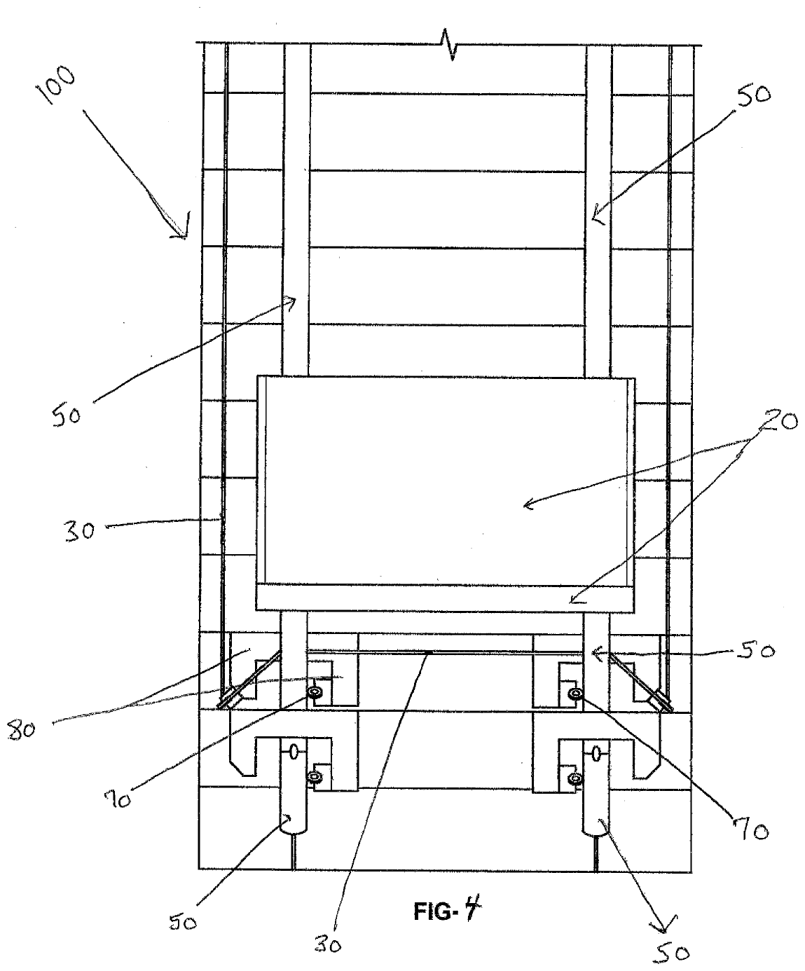

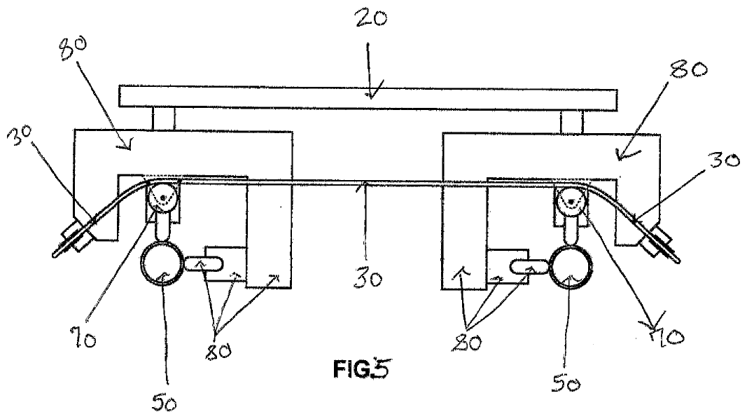

In another exemplary embodiment, dual pipe tracks 50 are connected to a plurality of metal support brackets 80 on both sides of the staircase 120 of the dual track rail system 40 spaced in intervals 130 with a plurality of guide wheels 70 to allow at least one steel braided cable 30 to pass over a plurality of cable guide wheels 70 and plurality of metal support brackets 80 to pull the pivot platform carriage 20 up and down the staircase (see FIG. 4). In one exemplary embodiment, at least one steel braided cable 30 passes over the cable guide wheels 70 mounted to the front end of the pivot platform carriage 20 to the opposite side of the staircase (not shown) on dual pipe tracks 50. At least one steel braided cable 30 then runs back up the staircase passing over the inside of the plurality of metal support brackets 80 guided by a plurality of guide wheels 70 to propel the lift up and down the staircase as shown in chassis and rail assembly (see FIG. 5). A skilled person in the art will appreciate the distance of the metal support brackets 80 connected in intervals to the dual pipe tracks 50 on the dual track rail system 40 to support a heavier weight capacity (See FIG. 1). In an exemplary embodiment, device 100 is configured to accommodate up to about 300 lbs weight capacity. In another embodiment, device 100 is configured to accommodate up to about 500 lbs of weight capacity. In yet another embodiment, device 100 is configured to accommodate up to about 750 lbs of weight capacity.

In an exemplary embodiment, device 100 comprises safety gates and safety switches at both the top and bottom of the staircase to prevent the entry of children and pets during operation (not shown). In another embodiment, device 100 comprises a small ramp at the bottom of the staircase to access a pivot platform carriage 20 for moving up or down the stairs through the middle of the docked carriage (not shown). In yet another embodiment, a pivot platform carriage 20 is equipped with a folding ramp in place of the carriage's lower door or gate to allow for a walker or other device other than a wheelchair to be transported on the lift device (not shown). A skilled person in the art will readily be able to appreciate the need for these alternative safety feature embodiments.

In one embodiment, a pivot platform carriage 20 includes a folding seat for passengers (not shown) configured to move up and down dual pipe tracks 50 by at least one steel braided cable 30 on both sides of the staircase 120 running from a power supply 90, located at the top of the staircase 120. In another embodiment, a pivot platform carriage 20 includes a folding seat for passengers (not shown) configured to move up and down dual pipe tracks 50 by at least one steel braided cable 30 on both sides of the staircase 120 running from a power supply 90, located at the bottom of the staircase 120. In one embodiment, power supply 90 comprises a battery, wired circuit, or 12-volt electric winch with rechargeable battery. In an embodiment, other conventional power supply 90 devices may be used, including a power supply which is integrated with a house-wide power source such as an alternating current source.

Thus, specific embodiments of a stair lift device and methods to employ such device have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A stair lift device to transport an individual up and down a staircase comprising:
(a) a dual track rail system located on both sides of a staircase, wherein said rail system is connected to a dual pipe track on both sides of said staircase;
(b) a plurality of metal support brackets,
wherein said metal support brackets run the length of said dual pipe track;
(c) at least one steel braided cable;
(d) a plurality of cable guide wheels connected to said plurality of metal support brackets;
(e) an electrical winch connected to said at least one steel braided cable; and
(f) a power supply, wherein said power supply is operably interconnected to said electrical winch.

2. The stair lift device of claim 1 wherein said dual pipe track is further connected to the staircase by metal bolts on both sides of the dual rail track.

3. The stair lift device of claim 1, comprising a pair of steel braided cables.

4. The stair lift device of claim 3, wherein said pair of steel braided cables are connected to said metal support brackets by metal bolts.

5. The stair lift device of claim 1, wherein said at least one steel braided cable runs along said metal support brackets guided by a plurality of said guide wheels to provide greater friction for support of heavier weight capacity users.

6. The stair lift device of claim 1, wherein said electrical winch is anchored at the top or bottom of the stairwell.

7. The stair lift device of claim 1, wherein said dual track rail system and said at least one steel braided cable run along the inner left and right side of the staircase.

8. The star lift device of claim 1, wherein said guide wheels are rollers integrated with a plurality of metal brackets.

9. The stair lift device of claim 1, wherein said plurality of metal support brackets comprise spacing about 3 cm to 25 cm apart.

10. The star lift device of claim 1, wherein said dual pipes are connected to a plurality of metal support brackets on both sides of the staircase in intervals with guide wheels configured for allowing the braided metal cables to pass over the guide wheels to pull a device up the lift.

11. The stair lift device of claim 1, wherein said lift device comprises safety gates and switches at the bottom and top of the stairwell.

12. The stair lift device of claim 1, wherein said single style pivot platform contains a ramp at the bottom of the staircase configured for docking.

13. A stair lift device to transport an individual up and down a staircase comprising:
(a) a pivot platform carriage, wherein said pivot platform carriage is hinged in the middle of the platform to allow turning movement of said pivot platform carriage on the staircase.

14. The stair lift device of claim 14, wherein said pivot platform carriage is further connected to a folding seat.

15. The stair lift device of claim 14, wherein said pivot platform carriage moves up and down dual pipe tracks by at least one steel braided cable on both sides of the staircase.

16. The star lift device of claim 14, wherein said pivot platform carriage is operably interconnected to a power supply connected at the top or bottom of the staircase.
